(19) United States
(12) Patent Application Publication
(10) Pub. No.: US 2007/0122568 A1
(43) Pub. Date: May 31, 2007

(54) Sound absorbing heat shield

(76) Inventor: Heinz Blömeling, Leichlingen (DE)

Correspondence Address: WILLIAM COLLARD;COLLARD & ROE, P.C., 1077 NORTHERN BOULEVARD, ROSLYN, NY, 11576, US

(21) Appl. No.: 10/574,627

(22) PCT Filed: Oct. 30, 2004
(86) PCT No.: PCT/EP04/12345

§ 371 Date: Apr. 5, 2006

(30) Foreign Application Priority Data
Dec. 12, 2003 (DE) 203 19 319.9

(51) Int. Cl. B60R 13/00

(52) U.S. Cl. 428/31; 160/38

(57) ABSTRACT

The invention relates to an acoustically effective heat shield, particularly for motor vehicles, having at least two metal foils, particularly aluminium foils, each of which has a plurality of knob-like embossed points, at least one of the metal foils being perforated. The perforated metal foil has a plurality of holes with an average hole diameter in the range from 0.05 to 0.9 mm. The holes are configured in the metal foil in a density of at least 15 holes per cm² and the perforated metal foil is provided on one side with an adhesive layer that can be heat-activated above 120° C. and that is correspondingly perforated. The metal foils, which have a thickness in the range from 50 to 200 Am, form a self-supporting composite. In particular, this self-supporting composite may be made up of not more than three adhesive-coated metal foils. In one variant, the self-supporting composite is made from two metal foils and an interposed layer made from a sound-absorbing material.

The invention relates to an acoustically effective heat shield, particularly for motor vehicles, having at least two metal foils, preferably made from aluminium, each of which has a plurality of knob-like embossed points, wherein at least one of the metal foils is perforated.

A sound absorbing heat shield that is made from at least two aluminium foils bonded with one another, and of which at least one foil has a plurality of knobs and fissures is known from European Patent No. EP 1 149 233 B1. The fissures are created by exceeding the elasticity threshold of the aluminium foil when the knobs are embossed, so that fissures are formed. To bond the aluminium foils to one another, the edges thereof are cold welded together. However, the structural strength of this foil bond would seem to warrant improvement, since it is suggested in European Patent No. EP 1 149 233 B1to supplement the foil bond with a supporting metal sheet.

A heat shield is also known from German Patent application No. DE 198 25 762 A1that includes a three-dimensional press-formed, multilayer metal foil structure. The heat shield is made from at least three superimposed aluminium foils. At(least two of the aluminium foils have a thickness of no more than 0.15 mm. The aluminium foils have a plurality of knob-like embossments to ensure that a space remains between superimposed aluminium foils. This heat shield is intended for use as an acoustic screen as well. However, its sound absorption capability is rather unsatisfactory.

The object underlying the present invention is to produce a heat shield for use in high-temperature zones of motor vehicles that possesses improved sound absorption capabilities and that has high structural strength even without the use of a supporting metal sheet.

This object is solved by a heat shield having the features of claim 1 as well as by a heat shield having the features of claim 7.

The heat shield according to the invention is constructed from at least two metal foils, preferably aluminium foils, each of which has a plurality of knob-like embossed points, wherein at least one of the metal foils is perforated. The perforated metal foil has a plurality of holes that have an average hole diameter in the range from 0.05 to 0.9 mm. The holes are formed in the metal foil in a density of at least 15 holes per cm², the perforated metal foil being provided on one side, preferably over the entire surface thereof, with an adhesive layer that is activated above 120° C., and which is correspondingly perforated. The metal foils, which have a thickness in a range from 50 to 200 μm, form a self-supporting composite.

This self-supporting composite can be formed particularly from not more than three adhesive coated metal foils.

In an equally advantageous variant, it is provided that at least one layer made from sound absorbing material is arranged between at least two of the metal foils, wherein said layer forms a self-supporting composite with the metal foils.

The invention provides a heat shield for high-temperature zones of a motor vehicle that demonstrates significantly improved sound absorption capability compared with conventional motor vehicle heat shields. Even without the otherwise standard use of a supporting metal sheet, the heat shield according to the invention has high structural strength.

Further preferred and advantageous embodiments of the heat shield according to the invention are described in the subordinate claims.

In the following, the invention will be explained in greater detail with reference to drawing showing several embodiments thereof. In the drawing:

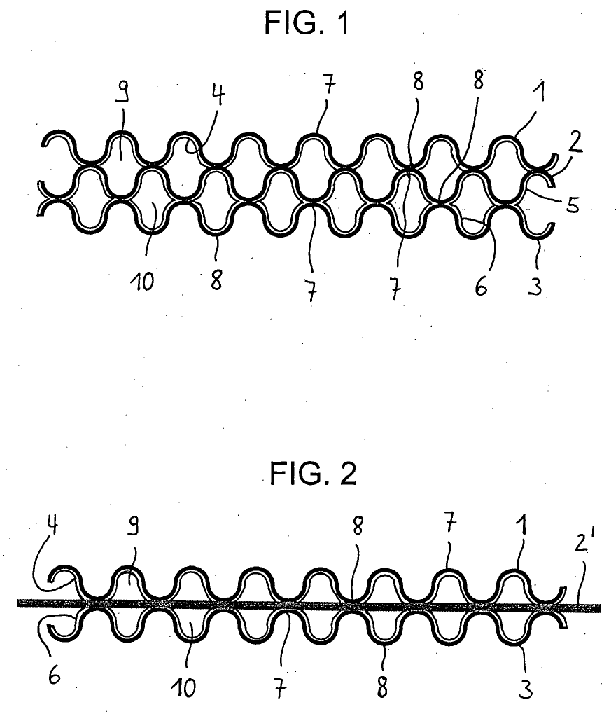

FIG. 1 is a schematic cross-sectional view of a portion of a heat shield according to a first embodiment of the invention;

FIG. 2 is a schematic cross-sectional view of a portion of a heat shield according to a second embodiment of the invention;

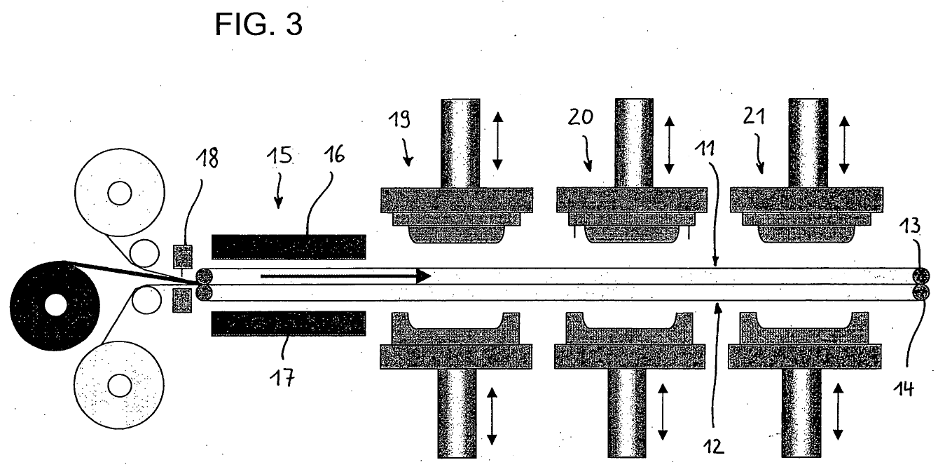

FIG. 3 is a schematic diagram of a device for manufacturing a heat shield according to the invention;

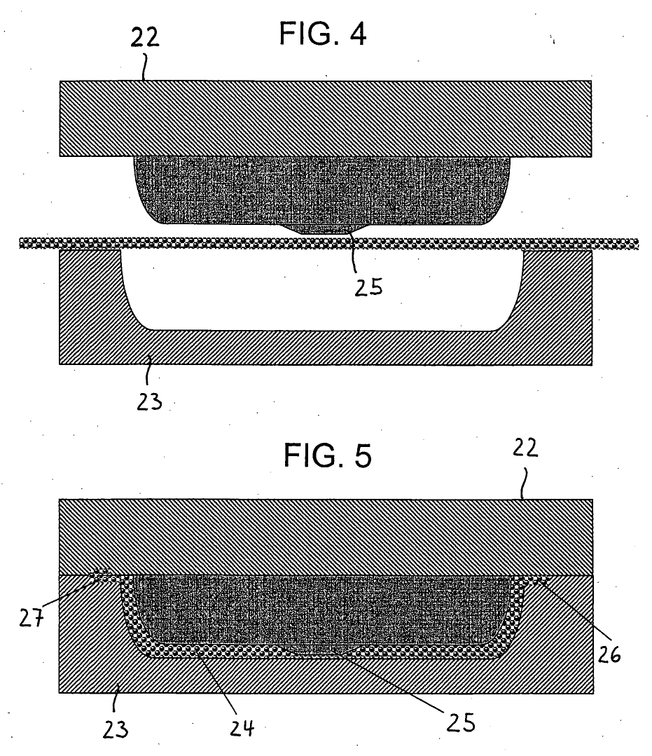

FIG. 4 is a schematic sectional view of a forming tool used in the device of FIG. 3 in the opened state;

FIG. 5 is a sectional view of a further forming tool used in the device of FIG. 3 in the closed state;

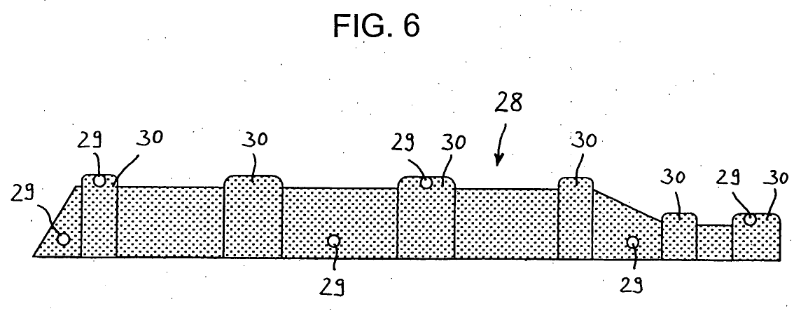

FIG. 6 is a schematic side view of a heat shield according to the invention.

FIG. 1 shows three superimposed plies 1, 2, 3 of a microperforated and embossed metal foil. The three plies or sections form a heat shield, which is not further shown. The heat shield has no supporting metal sheet, such as is usual to achieve adequate flexural rigidity and strength in conventional heat shields. The metal foil used in the heat shield according to the invention is preferably an aluminium foil. The thickness of the metal or aluminium foils is in the range from 50 to 200 μm, and the thickness of each is preferably about 90 μm. However, the metal or aluminium foils may also be of different thicknesses. The composite formed by the three plies 1, 2, 3 of microperforated, embossed metal or aluminium foils has a total thickness in the range from about 4 to 5 mm. Each of the three metal or aluminium foils are provided over the entire surface of one side thereof with an adhesive layer 4, 5, 6 that can be activated above 120° C., preferably above 150° C., and which is correspondingly perforated.

The microperforation in the metal foils is made up of a plurality of holes having an average hole diameter in the range from 0.05 to 0.9 mm. The holes are arranged in a density of at least 15 holes per cm² in the metal foil. The hole density is preferably at least 20 holes per cm².

The perforation of the metal foil coated with the adhesive layer is performed from the uncoated side of the metal foil, so that the shoulder of material surrounding each of the recess craters, raised away from the metal foil, is on the side of the adhesive layer.

The three metal foils are arranged in such manner that two metal foils each are bonded together by material means by at least one adhesive layer 4, 5 or 6. At least one of the two outer sides of the heat shield, preferably both outer sides, are not provided with an adhesive layer. The thickness of adhesive layer 4, 5, 6 is approx. 20 to 30 μm, so that the total thickness of the metal foil coated with the adhesive layer is for example 110 to 120 μm. After hardening, adhesive layer 4, 5, 6 may be exposed to high temperatures. It is preferably made from polyester adhesive and/or polyurethane adhesive.

The metal foils are embossed and each have a plurality of knob-like embossed points 7, 8. In the embodiment shown in FIG. 1, the individual embossed points or knobs 7, 8 are essentially dome-shaped. Knob-like embossed points 7, 8 are formed in the metal foils in a density of at least 100, preferably at least 150 embossed points per dm². The embossed points or knobs 7, 8 may also have one or more other shapes instead of a dome-shape (spherical cap shape). Embossed points and knobs that are frustum-shaped, pyramidal, lozenge-shaped, cuboid or cylindrical are also particularly suitable.

Embossed points or knobs 7, 8 have several functions. Firstly, they serve as spacing elements to create an air gap 9, 10 between two adjacent metal foils. Air gap 9, 10 in particular has a heat insulating effect. Secondly, embossed points or knobs 7, 8 serve to increase the surface of the respective metal film, which is advantageous for the purposes of the desired sound absorption. At moderately high sound frequencies, air gap 9 or 10 between the metal foils functions as the elastic spring in an acoustical spring-mass system. The sound absorbing effect of the heat shield is also enhanced by the microperforation of its metal foils. Noise is damped particularly via the effects of friction in the small holes in the metal foils. Thirdly embossed points or knobs 7, 8 increase the flexural rigidity and thus also the structural strength of the metal foil. The flexural stiffness of the metal foil and thus also the structural strength of the heat shield is particularly increased by the respective adhesive layer 4, 5, 6.

The microperforated metal foil or foils are embossed via at least one pair of embossing rollers (not shown), which has a plurality of knob-shaped embossing elevations on the mantle surface thereof. These embossing elevations are preferably arranged in a grid on the mantle surfaces of the embossing rollers, the distance between two embossing elevations on the respective roller being selected such that an embossing elevation can be immersed in the corresponding gap (clearance) on the paired counter roller without allowing the embossing elevations on the embossing rollers to come into contact with each other. The width of the die gap between the paired embossing rollers is selected such that the tips of the embossing elevations on the one embossing roller do not touch the roller surface of the respective counter roller. In this way, it is assured that the paired embossing rollers do not come into contact with each other and the small holes of the microperforation created previously in the metal foil are not compressed and closed up again when the embossed points or knobs 7, 8 are produced.

In the embodiment shown in FIG. 1, the three plies of the metal foil are arranged so that the embossed points 8 facing downwards in top ply 1 are coincident with the embossed points 7 that are facing upwards in middle ply 2. Accordingly, the embossed points 8 in the middle ply 2 that are facing downwards are coincident with embossed points 7 that are facing upwards in bottom ply 3.

In order to ensure that the embossed points of the respective metal foil do not engage the corresponding embossed points in the adjacent metal foil, which would prevent the formation of the desired air gap 9 or 10 between the immediately adjacent metal foils, according to a variant of the heat shield according to the invention that is not shown, two neighbouring metal foils may have a differing embossing pattern, in such manner that the one metal foil has a different embossing pattern than the other metal foil. In particular, to neighbouring metal foils may be differently embossed so that at least some of the knob-like embossed points in the one metal foil each have a larger diameter than the knob-like embossed points in the other metal foil.

FIG. 2 shows a further embodiment of a heat shield according to the invention. In this case too, the heat shield is not equipped with a supporting metal sheet. It differs from the heat shield of FIG. 1 in that it is made from only two plies 1, 3 of a correspondingly microperforated and embossed metal or aluminium foil, wherein a layer 2′ of fine-pored, sound absorbing material is arranged between these two plies 1, 3. Layer 2′ made from sound absorbing material has a mass per unit area in the range from 200 to 1200 g/m², preferably in the range from 250 to 1000 g/m². The sound absorbing material is made from a fibrous web material, preferably a polyester fibrous web material and/or mineral fibrous web material. The fibrous web material preferably contains 10 to 30 percent by weight of hotmelt adhesive fibres, particularly bicomponent hotmelt adhesive fibres. The hotmelt adhesive fibres increase the strength of the material composite. Microperforated, embossed metal or aluminium foils 1, 3 are bonded by material means with layer 2′ arranged therebetween via their respective adhesive layers. The composite thus formed by metal or aluminium foils 1, 3 and fine-pored layer 2′ has a total thickness in the range from about 5 to 20 mm.

In the following, the production of a heat shield according to the invention will be explained with reference to FIGS. 3 to 5. FIG. 3 is a schematic representation of an apparatus for manufacturing the heat shield. The apparatus includes a material transport device that includes two indexed driven endless conveyors 11 and 12, for example chain conveyors, belt conveyors or similar. The two endless conveyors 11, 12 are arranged one above the other. Drive rollers 13 and 14 are driven in the opposite direction, so that the endless chains or endless belts move in the same direction.

Three plies 1, 2, 3 of microperforated, embossed aluminium foil, which is provided on one side with a layer of thermally activatable adhesive, or two plies 1, 3 of a similar aluminium foil and an intermediate ply 2′ of fine-pored, sound absorbing material are unrolled from a supply rolls. Aluminium foils 1, 2, 3 or 1, 3 and intermediate ply 2′ of fine-pored, sound absorbing material where appropriate are fed to the material transport device and clamped at the edges between the endless chains of endless belts and/or are affixed to the edges thereof by fixing means (not shown).

A preheating and laminating station 15 is assigned to a first section of the material transport device, and is equipped with heating devices 16, 17, for example in the form of radiant heaters arranged above and below the endless conveyor. In preheating and laminating station 15, the heat-activated adhesive layer of the respective aluminium foils 1, 2, 3, or 1, 3, and where applicable hotmelt adhesive fibres contained in intermediate ply 2′ are activated or melted, with the result that the three plies 1, 2, 3 or 1, 2′, 3 are bonded together by material means.

Preheating and laminating station 15 is arranged downstream of a crosscutting device 18, which makes pre-cut parts adapted as far as possible to the dimensions of the heat shield to be manufactured from the supplied material strips. Several forming tools that are movable towards and away from each other, and which include at least a first forming tool 19 for forming a three-dimensionally shaped heat shield and at least a second forming tool 20 for trimming the edges of the heat shield and for producing fixing holes by corresponding punching are arranged after the preheating and laminating station 15 in the direction of feed. In addition, a further forming tool 21 is preferably provided to flange the edge of the heat shield. The flanging results in a smooth edge of the heat shield. Sharp edges that are likely to cause injury are thus avoided. In addition, the flanged edge increases the flexural stiffness of the heat shield.

The forming tools 19, 20., 21 that are shown schematically in FIG. 3 are shown enlarged and in somewhat greater detail, but still only schematically, in FIGS. 4 and 5, the right half of FIG. 5 corresponding to forming tool 20 and the left half of FIG. 5 corresponding to forming tool 21. The drawing makes clear that in the closed condition upper tool 22 and lower tool 23 define a tool gap 24. The gap width is adapted to the material combination of plies 1, 2, 3, or 1, 3, that are materially bonded to each other, wherein the second combination may include intermediate ply 2′ of fine-pored, sound absorbing material where applicable. The gap width is in the range from about 3 to 20 mm, particularly in the range from about 5 to 15 mm.

A protrusion 25 is conformed on each upper tool 22 and effects a relatively strong embossment of a partial area of the heat shield. The knob-like embossed points in the metal or aluminium foils are pressed flat in this partial area, which is used for the provision of a fixing hole or fixing member. After embossing, the metal or aluminium foils in this partial area are pressed flush against one another or flush against intermediate ply 2′ of fine-pored, sound absorbing material with no space.

Outer peripheral area 26, 27 of the cavity defined by upper tool 22 and lower tool 23 is conformed such that here the edge of the heat shield is either punched out (shown at right in FIG. 5) or flanged (shown at left in FIG. 5).

FIG. 6 shows a side view of an embodiment of a heat shield 28 according to the invention. This heat shield is intended for installation in the area of an exhaust system. Accordingly, it has a channel or tunnel shape. Several fixing holes 29 and strip-like rigidity embossments or corrugations 30 are formed in the heat shield 28, wherein the rigidity embossments or corrugations extend transversely to the longitudinal axis thereof. The fixing holes 29 are particularly arranged in the area of the rigidity embossment or beads 30.

The use and configuration of the heat shield according to the invention is not limited to its installation in the area of the exhaust system. In particular, the heat shield may also be arranged on a dash panel separating the engine compartment from the passenger cabin and may be shaped in a manner corresponding to the dash panel area to be covered.

1. Acoustically effective heat shield (28), particularly for motor vehicles, having at least two metal foils (1, 2,3), particularly made from aluminium, that have a thickness in the range from 50 to 200 μm and a plurality of knob-like embossed points (7, 8), wherein at least one of the metal foils (1, 2, 3) is perforated, the perforated metal foil (1, 2, 3) is furnished with a plurality of holes having an average hole diameter in the range from 0.05 to 0.9 mm, wherein the holes are arranged in a density of at least 15 holes per cm² in the metal foil, and that the perforated metal foil (1, 2, 3) is provided on one side with an adhesive layer (4, 5, 6) that is activatable by heating above 120° C., and which is correspondingly perforated, wherein the metal foils (1, 2, 3) form a self-supporting composite.

2. The heat shield according to claim 1, wherein two metal foils are each bonded with one another by at least one adhesive layer.

3. The heat shield according to claim 1, wherein two adjacent metal foils are differently embossed such that at least a part of the knob-like embossed points on the one metal foil each have a larger diameter than the knob-like embossed points on the other metal foil.

4. The heat shield according to claim 1, wherein two metal foils lying on each other are differently embossed such that the one metal foil has a different embossed pattern than the other metal foil.

5. The heat shield according to claim 1, wherein the self-supporting composite is formed from not more than three metal foils (1, 2, 3)

6. The heat shield according to claim 1, wherein the composite formed from metal foils has a thickness in the range from 4 to 5 mm.

7. Acoustically effective heat shield (28), particularly for motor vehicles, having at least two metal foils (1, 3), particularly made from aluminium, each of which has a plurality of knob-like embossed points (7, 8), wherein at least one of the metal foils (1, 2, 3) is perforated, wherein the perforated metal foil (1, 2, 3) has a plurality of holes with an average hole diameter in the range from 0.05 to 0.9 mm, wherein the holes are arranged in a density of at least 15 holes per cm² in the metal foil, that the perforated metal foil (1, 2, 3) is provided on one side with an adhesive layer (4, 5, 6) that is activatable by heating above 1200 C, and which is correspondingly perforated, and that at least one layer (2) of sound absorbing material is arranged between at least two of the metal foils (1, 3), which layer forms a self-supporting bond with the metal foils (1, 3).

8. The heat shield according to claim 7, wherein the layer (2) made from sound absorbing material has a mass per unit area in the range from 200 to 1200 g/m².

9. The heat shield according to claim 7, wherein the sound absorbing material is made from a fibrous web material, preferably a polyester and/or mineral fibrous web material.

10. The heat shield according to claim 9, wherein the fibrous web material contains 10 to 30 percent by weight hotmelt adhesive fibres, preferably bicomponent hotmelt adhesive fibres.

11. The heat shield according to claim 7, wherein the adhesive layer (4, 6) bonds the perforated metal foil to the layer (2) made from sound absorbing material.

12. The heat shield according to claim 7, wherein in that the self-supporting composite is formed from not more than two metal foils (1, 3) and not more than one layer (2′) of the sound absorbing material.

13. The heat shield according to claim 1, wherein the knob-like embossed points (7, 8) are formed in the metal foils (1, 2, 3) in a density of at least 100 embossed points, particularly in a density of at least 150 embossed points per dm².

14. The heat shield according to claim 1, wherein the hole density in the perforated metal foil (1, 2, 3) is at least 20 holes per cm².

15. The heat shield according to claim 1, wherein the metal foils (1, 2, 3) each have a thickness in the range from 50 to 110 μm.

16. The heat shield according to claim 1, wherein the adhesive layer has a thickness in the range from 20 to 30 μm.

17. The heat shield according to claim 1, wherein the metal foil (1, 2, 3) provided with the adhesive layer (4, 5, 6) is provided with the adhesive layer (4, 5, 6) over the entire surface thereof in each case.

18. The heat shield according to claim 1, wherein the adhesive layer (4, 5, 6) is made from polyester adhesive and/or polyurethane adhesive.

19. The heat shield according to claim 1, wherein the metal foils (1, 2, 3) are each microperforated and/or are provided on one side with an adhesive layer (4,5, 6) that is activatable by heating above 120° C.

20. The heat shield according to claim 1, wherein the outer sides thereof are not coated with an adhesive layer.

21. The heat shield (28) according to claim 1, wherein it has a channel-like shape with at least one striplike embossment for rigidity or corrugation (30) running transversely to its longitudinal extension.
